(19) United States
(12) Patent Application Publication
(10) Pub. No.: US 2013/0080757 A1
(43) Pub. Date: Mar. 28, 2013

(54) BOOTING METHOD AND BOOTING SYSTEM

(71) Applicant: PEGATRON CORPORATION, Taipei City (TW)

(72) Inventor: Yu-Wen CHOU, Taipei City (TW)

(73) Assignee: PEGATRON CORPORATION, Taipei City (TW)

(21) Appl. No.: 13/626,690

(22) Filed: Sep. 25, 2012

(30) Foreign Application Priority Data
Sep. 26, 2011 (TW) 100134670

(51) Int. Cl. G06F 9/00

(52) U.S. Cl. 713/2

(57) ABSTRACT

A booting method is used to an electronic apparatus including a storage device having a firmware image and a firmware recovery program, and comprises the steps of: starting a booting procedure and a timer; stopping the timer when a stop signal is received; and implementing a shutdown program, and overwriting the firmware image with the firmware recovery program or overwriting a command first implemented of the firmware image with a jump command to jump to the firmware recovery program, when the timer attains a specific time and the stop signal is not received.

### CROSS REFERENCE TO RELATED APPLICATIONS

This Non-provisional application claims priority under 35 U.S.C. §119(a) on Patent Application No(s). 100134670 filed in Taiwan, Republic of China on Sep. 26, 2011, the entire contents of which are hereby incorporated by reference.

### BACKGROUND

1. Technology Field

The disclosure relates to a booting method and a booting system and, in particular, to a booting method and a booting system used to an electronic apparatus.

2. Related Art

Computers have become indispensible articles either in work or life, providing the huge convenience for people. Just for this reason, the most torment for the people getting used to the computer is that the problem suddenly occurs to the computer such that the user can not continue to use it.

In the computer's design, a flash chip is not soldered onto the motherboard, but inserted into a chip socket on the motherboard. In this manner, when the firmware booting image stored in the flash chip is damaged, the flash chip can be drawn out and then reprogrammed, or can be replaced with a new flash chip.

However, this method is more complicated because an additional programming device is needed for writing a firmware image to the flash chip. Therefore, the user has no ability to repair the computer when facing this condition so they need to seek the assistance from the computer's repairman. Besides, the chip socket's height is larger than other chips, affecting the design of the mechanism.

Otherwise, the firmware image can be stored in two flash chips, and the firmware stored in only one of them is needed to be read to implement a booting procedure. Therefore, when one of the firmware images is damaged, the booting procedure also can be implemented by the other flash chip. Although, for this method the user needn't replace the firmware image by himself, but the additional flash chip makes the cost higher.

Therefore, it is important to provide a booting method and a booting system that can implement a booting procedure with a single memory chip and repair a damaged firmware image by itself.

### SUMMARY

The disclosure provides a booting method and a booting system that can implement a booting procedure with a single memory chip and repair a firmware image by itself when the firmware image is damaged.

To achieve the above objective, a booting method according to an embodiment of the invention is used to an electronic apparatus including a storage device having a firmware image and a firmware recovery program, and the booting method comprises the steps of: starting a booting procedure and a timer; stopping the timer when a stop signal is received; and implementing a shutdown program, and overwriting the firmware image with the firmware recovery program or overwriting a command first implemented of the firmware image with a jump command to jump to the firmware recovery program, when the timer attains a specific time and the stop signal is not received.

In one embodiment, the booting method further comprises the step of:

reading and implementing the program of the firmware image.

In one embodiment, the timer counts time from the specific time to zero or from zero to the specific time.

To achieve the above objective, a booting method according to an embodiment of the invention is used to an electronic apparatus including a storage device having a firmware image and a firmware recovery program, a control device and a processing device, and the booting method comprises the steps of: the control device starting a booting procedure and a timer; the processing device reading and implementing the program of the firmware image; and sending a stop signal to the control device to stop the timer if the result of the processing device implementing the program of the firmware image conforms to a successful booting condition; and implementing a shutdown program, and overwriting the firmware image with the firmware recovery program or overwriting a command first implemented of the firmware image with a jump command to jump to the firmware recovery program, if the timer attains a specific time and the control device doesn't receive the stop signal.

In one embodiment, the booting method further comprises the step of: the control device rebooting the electronic apparatus that was shut down; and the processing device implementing the firmware recovery procedure.

In one embodiment, the timer counts time from the specific time to zero or from zero to the specific time.

To achieve the above objective, a booting system according to an embodiment of the invention is used to an electronic apparatus, and comprises a storage device, a control device, and a processing device. The storage device includes a firmware image and a firmware recovery program. The control device is connected with the storage device and has a timer. The processing device is connected with the control device and reads the firmware image. A shutdown program is implemented, and the control device overwrites the firmware image with the firmware recovery program or overwrites a command first implemented of the firmware image with a jump command to jump to the firmware recovery program, when the timer attains a specific time and the control device doesn't receive a stop signal.

In one embodiment, the control device is an embedded micro-controller.

In one embodiment, the processing device is a central processing unit (CPU).

In one embodiment, the storage device further includes an embedded micro-controller firmware.

In one embodiment, the processing device sends the stop signal to the control device.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a flow chart of the booting method of a preferred embodiment of the invention;

FIG. 2 is a block diagram of a booting system according to the invention;

FIG. 3 is a flow chart of the booting method of the first embodiment of the invention; and

FIG. 4 is a flow chart of the booting method of the second embodiment of the invention.

### DETAILED DESCRIPTION OF THE INVENTION

The present invention will be apparent from the following detailed description, which proceeds with reference to the accompanying drawings, wherein the same references relate to the same elements.

The booting method disclosed by the invention is used to an electronic apparatus, such as a tablet electronic apparatus, a notebook electronic apparatus, or a desktop electronic apparatus. Particularly, the booting method of this embodiment is used to an electronic apparatus having a storage device. The storage device stores a firmware image and a firmware recovery program. The storage device is a flash chip for example. The firmware image is a compressed file, the content of which is at least partially compressed and includes the flash memory format information and function routines of several firms. After the decompression of the compressed file, the flash memory format information can be acquired and the function routines including erasing, writing and addressing, can be used, thereby the firmware image can be written to the flash chip.

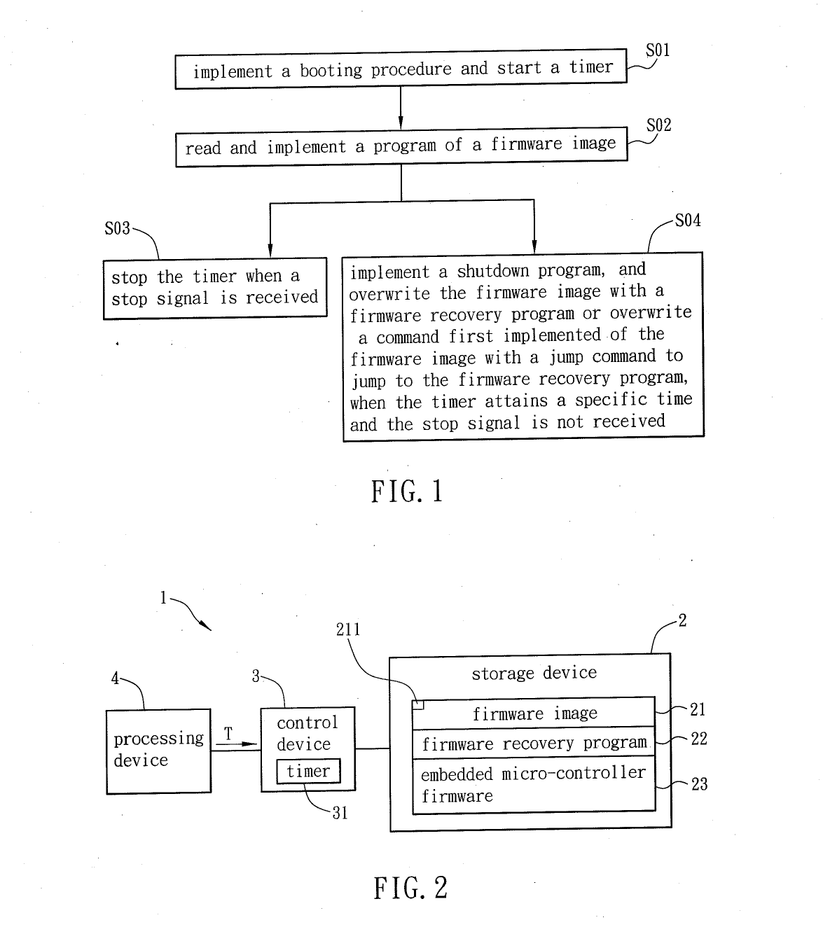

FIG. 1 is a flow chart of the booting method of a preferred embodiment of the invention, including the steps S01 to S04. The step S01 is to implement a booting procedure and start a timer. The step S02 is to read and implement a program of a firmware image. The step S03 is to stop the timer when a stop signal is received. The step S04 is to implement a shutdown program, and overwrite the firmware image with a firmware recovery program or overwrite a command first implemented of the firmware image with a jump command to jump to the firmware recovery program, when the timer attains a specific time and the stop signal is not received.

After implementing the step S02, the step S03 or S04 is determined to be implemented according to the result of implementing the firmware image.

The above is a brief description of the booting method of the embodiment. To be noted, the booting method is used to a booting system of an electronic apparatus, and can repair the booting procedure by itself when the booting procedure of the booting system is damaged.

FIG. 2 is a block diagram of a booting system of the embodiment. The booting system 1 includes a storage device 2, a control device 3, and a processing device 4. In the embodiment, the booting system 1 is used to an electronic apparatus, and configured to a motherboard (not shown).

The storage device 2 has a firmware image 21, a firmware recovery program 22, and an embedded micro-controller firmware 23.

The control device 3 is connected with the storage device 2. The control device 3 is an embedded micro-controller for example. The control device 3 includes a timer 31. The timer 31 has a specific time, and the timer 31 can count time from the specific time to zero, or from zero to the specific time. The specific time is less than one second, and preferably between 50 and 200 microseconds.

The processing device 4 is connected with the control device 3. In the embodiment, the processing device 4 is a central processing unit (CPU) for example.

Based on the steps S01 to S04 of the above-mentioned booting method, there are two instances of the booting method used to the booting system as shown in FIG. 2, and the detailed illustration thereof is provided as below.

### First Embodiment

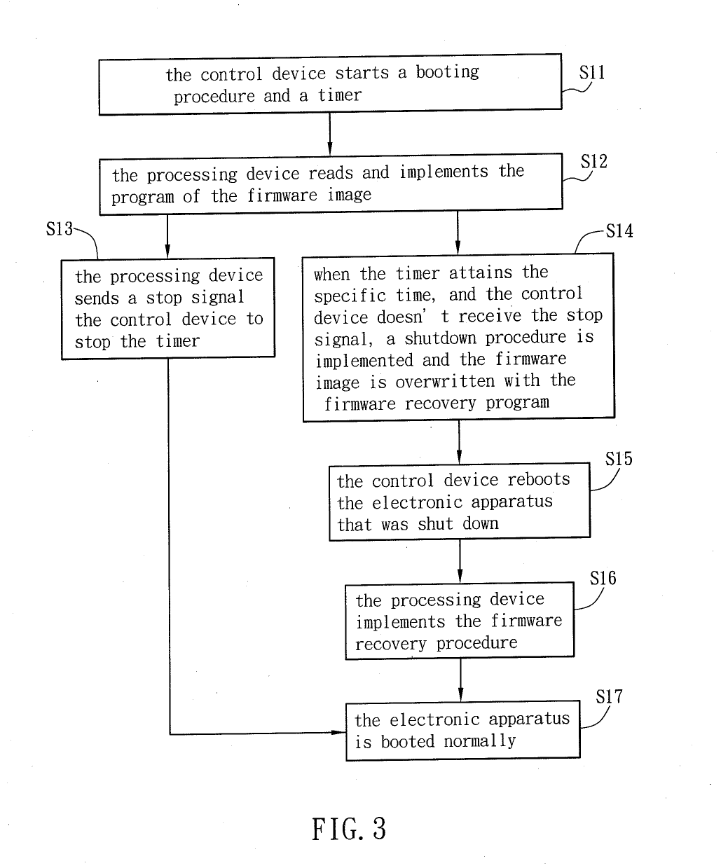

FIG. 3 is a flow chart of the booting method of the first embodiment of the invention. Referring to FIG. 3 in conjunction with FIG. 2, the booting method of this embodiment includes the steps S11 to S17.

In the step S11, the control device 3 starts a booting procedure and a timer 31. In detail, the control device 3 reads the embedded micro-controller firmware 23 stored in the storage device 2 to implement the booting procedure while starting the timer 31 to count time.

Then in the step S12, the processing device 4 reads and implements the program of the firmware image 21. In detail, the processing device 4 reads the firmware image 21 of the storage device 2 through the control device 3 to implement the program of the firmware image 21.

Subsequently, after implementing the step S12, the step S13 or S14 is determined to be implemented according to the result of the processing device 4 implementing the firmware image 21. In detail, if the result of the processing device 4 implementing the firmware image 21 conforms to a successful booting condition, the step S13 is implemented after the step S12. However, if the result of the processing device 4 implementing the firmware image 21 doesn't conform to a successful booting condition, the step S14 is implemented after the step S12.

In the step S13, the processing device 4 sends a stop signal T to the control device 3 to stop the timer 31. In detail, if the result of the processing device 4 implementing the firmware image 21 conforms to the successful booting condition, the processing device 4 sends the stop signal T to control device 3 to stop the timer 31. In more detail, the result doesn't conforms to the successful booting condition until the processing device 4 implements a firmware recovery section of a boot block of the program of the firmware image 21. The processing device 4 sends the stop signal T to the control device 3, and the timer 31 stops counting time according to the stop signal T.

Finally, in the step S17, the electronic apparatus is booted normally.

Otherwise, in the step S14, when the timer 31 attains the specific time, and the control device 3 doesn't receive the stop signal T, a shutdown procedure is implemented and the firmware image 21 is overwritten with the firmware recovery program 22. In detail, if the control device 3 doesn't receive the stop signal T and the timer 31 completes the time counting from the specific time to zero or from zero to the specific time, the control device 3 shuts down the system and implements the firmware recovery procedure, which means the control device 3 overwrites the firmware image 21 with the firmware recovery program 22.

Then in the step S15, the control device 3 reboots the electronic apparatus that was shut down. The control device 3 reads the embedded micro-controller firmware 23 of the storage device 2 to implement the booting procedure.

In more detail, in the steps S14 and S15, the control device 3 overwrites the firmware image 21 with the firmware recovery program 22, and then implements the booting procedure again. Subsequently, the processing device 4 reads the firmware recovery program 22 to implement the booting procedure.

In the step S16, the processing device 4 implements the firmware recovery procedure. The processing device 4 reads a firmware image from a storage media of the system, such as an USB disk, a hard disk, or an optical disk driver, and then overwrites the firmware image 21 stored in the storage device 2 with the new firmware image.

Finally, in the step S17, the electronic apparatus is booted normally.

### Second Embodiment

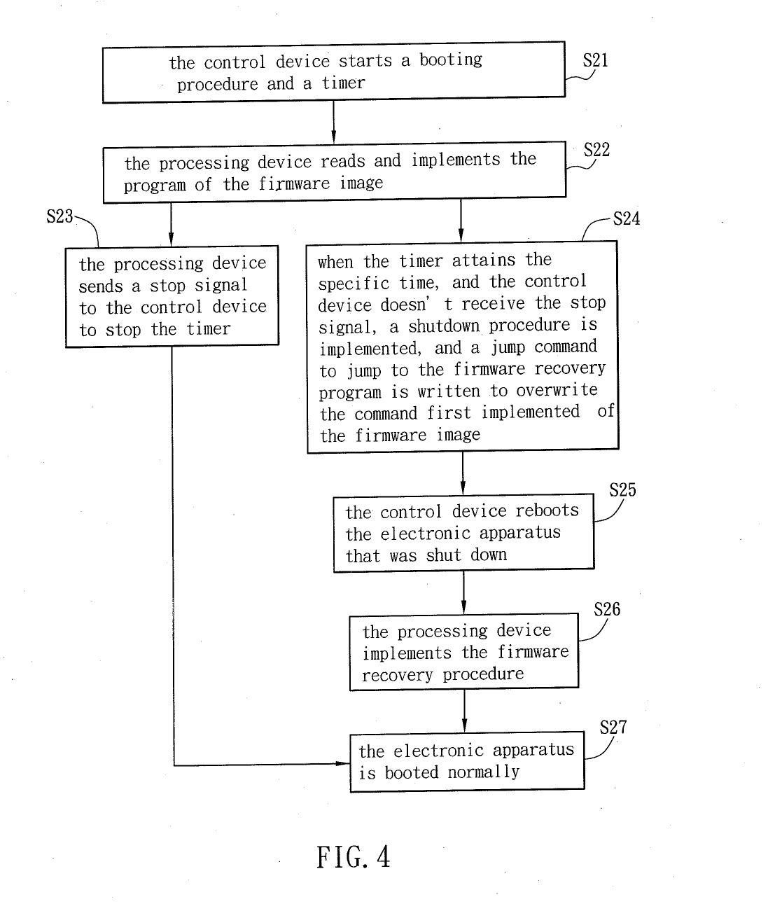

FIG. 4 is a flow chart of the booting method of the second embodiment of the invention. Referring to FIG. 4 in conjunction with FIG. 2, the booting method of this embodiment includes the steps S21 to S27.

In the step S21, the control device 3 starts a booting procedure and a timer 31. In the step S22, the processing device 4 reads and implements the program of the firmware image 21. Because the steps S21 and S22 have the same features as the steps S11 and S12, the detailed descriptions are omitted here.

Subsequently, after implementing the step S22, the step S23 or S24 is determined to be implemented according to the result of the processing device 4 implementing the firmware image 21. In detail, if the result of the processing device 4 implementing the firmware image 21 conforms to a successful booting condition, the step S23 is implemented after the step S22. However, if the result of the processing device 4 implementing the firmware image 21 doesn't conform to a successful booting condition, the step S24 is implemented after the step S22.

In the step S23, the processing device 4 sends a stop signal T to the control device 3 to stop the timer 31. In detail, the result doesn't conforms to the successful booting condition until the processing device 4 implements a firmware recovery section of a boot block of the program of the firmware image 21. The processing device 4 sends the stop signal T to the control device 3, and the timer 31 stops counting time according to the stop signal T.

Finally, in the step S27, the electronic apparatus is booted normally.

Otherwise, in the step S24, when the timer 31 attains the specific time, and the control device 3 doesn't receive the stop signal T, a shutdown procedure is implemented, and a jump command to jump to the firmware recovery program 22 is written to overwrite the command 211 first implemented of the firmware image 21. If the control device 3 doesn't receive the stop signal T and the timer 31 completes the time counting from the specific time to zero or from zero to the specific time, the control device 3 shuts down the system and implements the firmware recovery procedure, which means the control device 3 writes a jump command to jump to the firmware recovery program 22 to overwrite the command 211 first implemented of the firmware image 21.

Then in the step S25, the control device 3 reboots the electronic apparatus that was shut down. The control device 3 reads the embedded micro-controller firmware 23 of the storage device 2 to implement the booting procedure.

In more detail, in the steps S24 and S25, the control device 3 writes a jump command to overwrite the first command 211 of the firmware image 21, and then implements the booting procedure again. Subsequently, when the processing device 4 reads the first command 211 of the firmware image 21, it will jump to and read the firmware recovery program 22 to implement the booting procedure.

In the step S26, the processing device 4 implements the firmware recovery procedure. The processing device 4 reads a firmware image from a storage media of the system, such as an USB disk, a hard disk, or an optical disk driver, and then overwrites the firmware image 21 stored in the storage device 2 with the new firmware image.

Finally, in the step S27, the electronic apparatus is booted normally.

In summary, according to a booting method and a booting system of the invention, when the electronic apparatus is turned on, the control device starts the timer and the processing device reads the firmware image. When the timer attains the specific time and the processing device doesn't implement the firmware recovery section of the firmware image yet, the control device overwrites the firmware image with the firmware recovery program and then implements the booting procedure again. Otherwise, the control device can overwrite the command first implemented of the firmware image with a jump command to jump to the firmware recovery program, and then implement the booting procedure again.

Compared with the conventional art, the booting method and the booting system of the invention can implement a booting procedure with a single memory chip and repair a damaged firmware image by itself with not much booting time.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A booting method used to an electronic apparatus including a storage device having a firmware image and a firmware recovery program, comprising the steps of:
starting a booting procedure and a timer;
stopping the timer when a stop signal is received; and
implementing a shutdown program, and overwriting the firmware image with the firmware recovery program or overwriting a command first implemented of the firmware image with a jump command to jump to the firmware recovery program, when the timer attains a specific time and the stop signal is not received.

2. The booting method as recited in claim 1, further comprising the step of:
reading and implementing the program of the firmware image.

3. The booting method as recited in claim 1, wherein the timer counts time from the specific time to zero or from zero to the specific time.

4. A booting method used to an electronic apparatus including a storage device having a firmware image and a firmware recovery program, a control device and a processing device, comprising the steps of:
the control device starting a booting procedure and a timer;
the processing device reading and implementing the program of the firmware image; and
sending a stop signal to the control device to stop the timer if the result of the processing device implementing the program of the firmware image conforms to a successful booting condition; implementing a shutdown program, and overwriting the firmware image with the firmware recovery program or overwriting a command first implemented of the firmware image with a jump command to jump to the firmware recovery program, if the timer attains a specific time and the control device doesn't receive the stop signal.

5. The booting method as recited in claim 4, further comprising the step of:
the control device rebooting the electronic apparatus that was shut down; and
the processing device implementing the firmware recovery procedure.

6. The booting method as recited in claim 4, wherein the timer counts time from the specific time to zero or from zero to the specific time.

7. A booting system used to an electronic apparatus, comprising:
a storage device including a firmware image and a firmware recovery program;
a control device connected with the storage device and having a timer; and
a processing device connected with the control device and reading the firmware image, wherein a shutdown program is implemented, and the control device overwrites the firmware image with the firmware recovery program or overwrites a command first implemented of the firmware image with a jump command to jump to the firmware recovery program, when the timer attains a specific time and the control device doesn't receive a stop signal.

8. The booting system as recited in claim 7, wherein the control device is an embedded micro-controller.

9. The booting system as recited in claim 7, wherein the processing device is a central processing unit (CPU).

10. The booting system as recited in claim 7, wherein the storage device further includes an embedded micro-controller firmware.

11. The booting system as recited in claim 7, wherein the processing device sends the stop signal to the control device.
